(19) United States
(12) Patent Application Publication
(10) Pub. No.: US 2025/0300226 A1
(43) Pub. Date: Sep. 25, 2025

(54) ELECTROLYTE FORMULATION FOR BATTERIES

(71) Applicant: GM GLOBAL TECHNOLOGY OPERATIONS LLC, Detroit, MI (US)

(72) Inventors: Chuanlong Wang, Troy, MI (US); Xiaosong Huang, Novi, MI (US)

(73) Assignee: GM GLOBAL TECHNOLOGY OPERATIONS LLC, Detroit, MI (US)

(21) Appl. No.: 18/611,906

(22) Filed: Mar. 21, 2024

(51) Int. Cl. H01M 10/0567; B60L 50/60; H01M 10/0568; H01M 10/0569

(52) U.S. Cl. CPC H01M 10/0567; B60L 50/60; H01M 10/0568; H01M 10/0569; H01M 2220/20; H01M 2300/0034; H01M 2300/0037

(57) ABSTRACT

An electrolyte formulation for a battery is provided. The electrolyte formulation includes a lithium salt in a carbonate-based solution, and lithium difluoro(bisoxalato) phosphate present in the electrolyte formulation in an amount from 0.1 part by weight to 5 parts by weight based on 100 parts by weight of the electrolyte formulation.

### INTRODUCTION

The disclosure generally relates to electrolyte formulations for batteries.

Battery cells may include an anode, a cathode, an electrolyte formulation, and a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A battery cell includes an electrolyte formulation which provides lithium-ion conduction paths between the anode and the cathode. The electrolyte is an ionic conductor. The electrolyte is additionally an electronically insulating material.

Hybrid electric and full electric (collectively “electric-drive”) powertrains take on various architectures, some of which utilize a battery system to supply power for one or more electric traction motors.

### SUMMARY

According to one embodiment, an electrolyte formulation for a battery includes a lithium salt in a carbonate-based solution, and lithium difluoro(bisoxalato) phosphate present in the electrolyte formulation in an amount from 0.1 part by weight to 5 parts by weight based on 100 parts by weight of the electrolyte formulation.

In some embodiments, the lithium difluoro(bisoxalato) phosphate is present in the electrolyte formulation in an amount from 0.5 part by weight to 2.5 parts by weight based on 100 parts by weight of the electrolyte formulation.

In some embodiments, the lithium difluoro(bisoxalato) phosphate is present in the electrolyte formulation in an amount of 1 part by weight to 2 parts by weight based on 100 parts by weight of the electrolyte formulation.

In some embodiments, the lithium salt is selected from the group consisting of lithium hexafluorophosphate, lithium tetrafluoroborate, lithium bis(trifluoromethanesulfonyl)imide, lithium bis(oxalato)borate, and lithium perchlorate, wherein the lithium salt is present in an amount from 0.5 mole to 4 moles per 1 liter of the carbonate-based solution.

In some embodiments, the lithium salt includes lithium hexafluorophosphate.

In some embodiments, the lithium salt includes lithium hexafluorophosphate, wherein the lithium hexafluorophosphate is present in an amount from 0.5 to 4 moles per 1 liter of the carbonate-based solution.

In some embodiments, the carbonate-based solution includes two solvents selected from the group consisting of dimethyl carbonate, diethyl carbonate, ethylene carbonate, ethyl methyl carbonate, fluoroethylene carbonate, vinylene carbonate and propylene carbonate, wherein the two solvents are present in a mixing ratio of from 1:99 to 99:1.

In some embodiments, the carbonate-based solution includes ethylene carbonate and dimethyl carbonate present in a ratio ranging from 2 parts ethylene carbonate to 9 parts dimethyl carbonate to 6 parts ethylene carbonate to 9 parts dimethyl carbonate.

In some embodiments, the carbonate-based solution includes fluoroethylene carbonate and diethyl carbonate present in a ratio ranging from 1 part fluoroethylene carbonate to 9 parts diethyl carbonate to 4 parts fluoroethylene carbonate to 9 parts diethyl carbonate.

In some embodiments, the carbonate-based solution includes ethylene carbonate and dimethyl carbonate present in a ratio of 3 parts ethylene carbonate to 7 parts dimethyl carbonate.

In some embodiments, the carbonate-based solution includes fluoroethylene carbonate and diethyl carbonate present in a ratio of 1 part fluoroethylene carbonate to 4 parts diethyl carbonate.

In some embodiments, the lithium salt includes lithium hexafluorophosphate present in an amount from 0.5 mole to 4 moles per 1 liter of the carbonate-based solution, wherein the carbonate-based solution includes ethylene carbonate and dimethyl carbonate present in a ratio of 3 parts ethylene carbonate to 7 parts dimethyl carbonate.

In some embodiments, the lithium salt includes lithium hexafluorophosphate present in an amount from 0.5 mole to 4 moles per 1 liter of the carbonate-based solution, wherein the carbonate-based solution includes fluoroethylene carbonate and diethyl carbonate present in a ratio of 1 part fluoroethylene carbonate to 4 parts diethyl carbonate.

According to another embodiment, a battery includes an anode, a cathode and an electrolyte formulation, wherein the electrolyte formulation includes a lithium salt in a carbonate-based solution, and lithium difluoro(bisoxalato) phosphate present in the electrolyte formulation in an amount from 0.1 part by weight to 5 parts by weight based on 100 parts by weight of the electrolyte formulation.

In some embodiments, the anode is a graphite- and/or silicon-based anode, and the graphite- and/or silicon-based anode includes a material selected from the group consisting of (i) silicon, (ii) silicon monoxide, (iii) silicon carbide, (iv) LiₓSiO_{y}, (v) a blend of any of (i)-(iv), (vi) any of (i)-(v) mixed or coated with graphite, and (vii) graphite.

In some embodiments, the cathode is a nickel-based cathode, and the nickel-based cathode is a mixture including one or more of a nickel-cobalt-manganese-aluminum mixture, a lithium- and manganese-rich layered oxide mixture, a lithium-nickel-manganese-oxide mixture, a nickel-manganese-cobalt mixture, a nickel-cobalt-aluminum mixture, an olivine LiMnₓFe₁₋ₓPO₄ mixture, a lithium-iron-phosphate mixture and a lithium manganese (III,IV) oxide mixture.

In some embodiments, the lithium difluoro(bisoxalato) phosphate is present in the electrolyte formulation in an amount from 0.5 part by weight to 2.5 parts by weight based on 100 parts by weight of the electrolyte formulation, and the lithium salt includes lithium hexafluorophosphate present in an amount from 0.5 moles to 4 moles per 1 liter of the carbonate-based solution.

In some embodiments, the carbonate-based solution includes either (i) ethylene carbonate and dimethyl carbonate present in a ratio ranging from 2 parts ethylene carbonate to 9 parts dimethyl carbonate to 6 parts ethylene carbonate to 9 parts dimethyl carbonate, or (ii) fluoroethylene carbonate and diethyl carbonate present in a ratio ranging from 1 part fluoroethylene carbonate to 9 parts diethyl carbonate to 4 parts ethylene carbonate to 9 parts diethyl carbonate.

According to yet another embodiment, a device includes an output component and a battery configured for providing electrical energy to the device, wherein the battery includes an anode, a cathode and an electrolyte formulation, and wherein the electrolyte formulation includes a lithium salt in a carbonate-based solution and lithium difluoro(bisoxalato) phosphate present in the electrolyte formulation in an amount from 0.1 part by weight to 5 parts by weight based on 100 parts by weight of the electrolyte formulation.

In some embodiments, the lithium difluoro(bisoxalato) phosphate is present in the electrolyte formulation in an amount from 0.5 part by weight to 2.5 parts by weight based on 100 parts by weight of the electrolyte formulation, wherein the lithium salt includes lithium hexafluorophosphate present in an amount from 0.5 moles to 4 moles per 1 liter of the carbonate-based solution, and wherein the carbonate-based solution includes either (i) ethylene carbonate and dimethyl carbonate present in a ratio ranging from 2 parts ethylene carbonate to 9 parts dimethyl carbonate to 6 parts ethylene carbonate to 9 parts dimethyl carbonate, or (ii) fluoroethylene carbonate and diethyl carbonate present in a ratio ranging from 1 part fluoroethylene carbonate to 9 parts diethyl carbonate to 4 parts ethylene carbonate to 9 parts diethyl carbonate.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic view of an exemplary battery including the disclosed electrolyte formulation, in accordance with the present disclosure.

FIG. 2 is a schematic view of an exemplary device embodied by a vehicle equipped with the battery of FIG. 1, in accordance with the present disclosure.

FIG. 3 is a graph illustrating exemplary test results of a relationship between specific capacity of a battery and a number of operation cycles through which the battery is operated for a plurality of electrolyte formulations, in accordance with a first embodiment of the present disclosure.

FIG. 4 is a graph illustrating exemplary test results of a relationship between capacity retention of a battery and a number of operation cycles through which the battery is operated for a plurality of electrolyte formulations, in accordance with the first embodiment of the present disclosure.

FIG. 5 is a graph illustrating exemplary test results of a relationship between areal capacity of a battery and a number of operation cycles through which the battery is operated for a plurality of electrolyte formulations, in accordance with a second embodiment of the present disclosure.

FIG. 6 is a graph illustrating exemplary test results of a relationship between capacity retention of a battery and a number of operation cycles through which the battery is operated for a plurality of electrolyte formulations, in accordance with the second embodiment of the present disclosure.

### DETAILED DESCRIPTION

During operation of a battery, chemical reactions taking place between a battery's anode and electrolyte formulation may cause a solid electrolyte interphase (SEI) layer to be formed upon an anode. Similarly, chemical reactions taking place between the battery's cathode and the electrolyte formulation cause a cathode electrolyte interphase (CEI) layer to be formed upon a cathode. The SEI layer and the CEI layer form as films upon the anode and cathode, respectively.

Increased stability in the SEI layer and the CEI layer may provide improved useful life or increased electrode capacity retention in the anode and cathode, respectively.

Lithium hexafluorophosphate (LiPF₆) based electrolyte formulations in use within a battery may develop reactive species, such as hydrofluoric acid (HF). HF may interfere with interfacial structures of electrodes and cause degradation of the electrode surface that may contribute to capacity reduction over multiple operation cycles of the battery.

A cathode may be nickel based and may include manganese. Over multiple operation cycles of the battery, nickel and manganese may suffer from dissolution or may leach out of the cathode, thereby contributing to capacity reduction of the battery.

An electrolyte formulation is disclosed herein which provides excellent cycle life for a battery. The battery may include a graphite- and/or silicon-based anode and a nickel-based or nickel-rich cathode. The electrolyte formulation includes a lithium salt in a carbonate-based solution. The electrolyte formulation further includes lithium difluoro(bisoxalato) phosphate (LiDFBOP) present in the electrolyte formulation in an amount from 0.1 part by weight to 5 parts by weight based on 100 parts by weight of the electrolyte formulation. In some embodiments, the lithium difluoro(bisoxalato) phosphate may be present in the electrolyte formulation in an amount from 0.5 part by weight to 2.5 parts by weight based on 100 parts by weight of the electrolyte formulation. In other embodiments, the lithium difluoro(bisoxalato) phosphate may be present in the electrolyte formulation in an amount from 1 part by weight to 2 parts by weight based on 100 parts by weight of the electrolyte formulation.

The lithium salt may be selected from the group consisting of lithium hexafluorophosphate, lithium tetrafluoroborate, lithium bis(trifluoromethanesulfonyl)imide, lithium bis(oxalato)borate, and lithium perchlorate. The lithium salt may be present in an amount from 0.5 moles to 4 moles per 1 liter of the carbonate-based solution. For example, the lithium salt may include lithium hexafluorophosphate, which may be present in an amount from 0.5 moles to 4 moles per 1 liter of the carbonate-based solution.

The carbonate-based solution may include two solvents selected from the group consisting of dimethyl carbonate (DMC), diethyl carbonate (DEC), ethylene carbonate (EC), ethyl methyl carbonate (EMC), fluoroethylene carbonate (FEC), vinylene carbonate (VC) and propylene carbonate (PC). The two solvents may be present in a mixing ratio of from 1:99 to 99:1.

The carbonate-based solution may include ethylene carbonate and dimethyl carbonate present in a ratio ranging from 2 parts ethylene carbonate to 9 parts dimethyl carbonate to 6 parts ethylene carbonate to 9 parts dimethyl carbonate. For example, the carbonate-based solution may include ethylene carbonate and dimethyl carbonate present in a ratio of 3 parts ethylene carbonate to 7 parts dimethyl carbonate. Alternatively, the carbonate-based solution may include fluoroethylene carbonate and diethyl carbonate present in a ratio ranging from 1 part fluoroethylene carbonate to 9 parts diethyl carbonate to 4 parts fluoroethylene carbonate to 9 parts diethyl carbonate. For example, the carbonate-based solution may include fluoroethylene carbonate and diethyl carbonate present in a ratio of 1 part fluoroethylene carbonate to 4 parts diethyl carbonate.

In one embodiment, the lithium salt may include lithium hexafluorophosphate present in an amount from 0.5 mole to 4 moles per 1 liter of the carbonate-based solution, wherein the carbonate-based solution includes ethylene carbonate and dimethyl carbonate present in a ratio of 3 parts ethylene carbonate to 7 parts dimethyl carbonate. In another embodiment, the lithium salt includes lithium hexafluorophosphate present in an amount from 0.5 mole to 4 moles per 1 liter of the carbonate-based solution, wherein the carbonate-based solution includes fluoroethylene carbonate and diethyl carbonate present in a ratio of 1 part fluoroethylene carbonate to 4 parts diethyl carbonate. In either of these two embodiments, the electrolyte formulation may include excellent cycle performance and capacity retention by further including lithium difluoro(bisoxalato) phosphate at 0.1% by weight to 5.0% by weight of the electrolyte formulation. Also in either of these two embodiments, the electrolyte formulation may include excellent cycle performance and capacity retention by further including lithium difluoro(bisoxalato) phosphate at 0.5% by weight to 2.5% by weight of the electrolyte formulation. Further in either of these two embodiments, the electrolyte formulation may include excellent cycle performance and capacity retention by further including lithium difluoro(bisoxalato) phosphate at 1.0% by weight to 2.0% by weight of the electrolyte formulation.

The inclusion of LiDFBOP in the disclosed electrolyte formulation includes a plurality of benefits. Presence of LiDFBOP in the disclosed concentration range promotes formation of a stable interphase upon the anode and the cathode. LiDFBOP may sacrificially decompose and form stable electrode/electrolyte interphases (containing inorganic boron, fluorine, and carbonate compounds.)

Presence of LiDFBOP in the disclosed concentration range promotes scavenging of HF within the electrolyte formulation or reduces presence of HF in the electrolyte formulation. LiDFBOP may sequester phosphorus pentafluoride PF₅ (from lithium hexafluorophosphate (LiPF₆) salt), which may reduce an amount of HF formation. HF may consume Li ions to form lithium fluoride (LiF) which may be deposited on a surface of the electrodes.

Presence of LiDFBOP in the disclosed concentration range mitigates dissolution or migration of nickel and manganese in the cathode.

The disclosed electrolyte formulation may be utilized in a wide variety of batteries, including but not limited to lithium-ion, lithium-metal and lithium sulfur/oxygen batteries.

According to another embodiment, a battery is provided. The battery includes an anode, a cathode and an electrolyte formulation, wherein the electrolyte formulation includes a lithium salt in a carbonate-based solution, and lithium difluoro(bisoxalato) phosphate present in the electrolyte formulation in an amount from 0.1 part by weight to 5 parts by weight based on 100 parts by weight of the electrolyte formulation.

The anode may be a graphite- and/or silicon-based anode, and the graphite- and/or silicon-based anode may include a material selected from the group consisting of (i) silicon, (ii) silicon monoxide, (iii) silicon carbide, (iv) LiₓSiO_{y}, (v) a blend of any of (i)-(iv), (vi) any of (i)-(v) mixed or coated with graphite, and (vii) graphite.

The cathode may be a nickel-based or nickel-rich cathode, and may be a mixture including one or more of a nickel-cobalt-manganese-aluminum mixture (NCMA), a lithium- and manganese-rich layered oxide mixture (LMR), a lithium-nickel-manganese-oxide mixture (LNMO), a nickel-manganese-cobalt mixture (NMC), a nickel-cobalt-aluminum mixture (NCA), an olivine LiMnₓFe₁₋ₓPO₄ mixture (LMFP), a lithium-iron-phosphate mixture (LFP) and a lithium manganese (III,IV) oxide mixture (LMO).

The lithium difluoro(bisoxalato) phosphate may be present in the electrolyte formulation in an amount from 0.5 part by weight to 2.5 parts by weight based on 100 parts by weight of the electrolyte formulation, and the lithium salt may include lithium hexafluorophosphate present in an amount from 0.5 moles to 4 moles per 1 liter of the carbonate-based solution.

The carbonate-based solution may include either (i) ethylene carbonate and dimethyl carbonate present in a ratio ranging from 2 parts ethylene carbonate to 9 parts dimethyl carbonate to 6 parts ethylene carbonate to 9 parts dimethyl carbonate, or (ii) fluoroethylene carbonate and diethyl carbonate present in a ratio ranging from 1 part fluoroethylene carbonate to 9 parts diethyl carbonate to 4 parts ethylene carbonate to 9 parts diethyl carbonate.

According to yet another embodiment, a device is provided. The device includes an output component and a battery configured for providing electrical energy to the device, wherein the battery includes an anode, a cathode and an electrolyte formulation, and wherein the electrolyte formulation includes a lithium salt in a carbonate-based solution and lithium difluoro(bisoxalato) phosphate present in the electrolyte formulation in an amount from 0.1 part by weight to 5 parts by weight based on 100 parts by weight of the electrolyte formulation.

The lithium difluoro(bisoxalato) phosphate may be present in the electrolyte formulation in an amount from 0.5 part by weight to 2.5 parts by weight based on 100 parts by weight of the electrolyte formulation, wherein the lithium salt may include lithium hexafluorophosphate present in an amount from 0.5 moles to 4 moles per 1 liter of the carbonate-based solution, and wherein the carbonate-based solution may include either (i) ethylene carbonate and dimethyl carbonate present in a ratio ranging from 2 parts ethylene carbonate to 9 parts dimethyl carbonate to 6 parts ethylene carbonate to 9 parts dimethyl carbonate, or (ii) fluoroethylene carbonate and diethyl carbonate present in a ratio ranging from 1 part fluoroethylene carbonate to 9 parts diethyl carbonate to 4 parts ethylene carbonate to 9 parts diethyl carbonate.

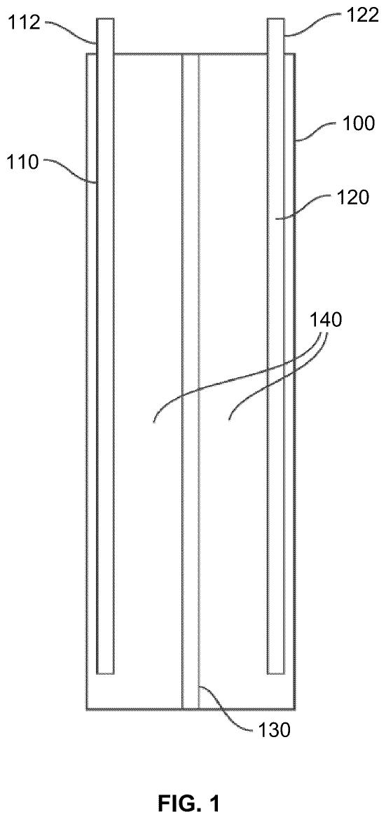

Referring now to the drawings, wherein like reference numbers refer to like features throughout the several views, FIG. 1 schematically illustrates an exemplary battery cell 100, including an anode 110, a cathode 120, a separator 130, and an electrolyte formulation 140. The battery cell 100 enables converting electrical energy into stored chemical energy in a charging cycle, and the battery cell 100 enables converting stored chemical energy into electrical energy in a discharging cycle. A negative current collector 112 is illustrated connected to the anode 110, and a positive current collector 122 is illustrated connected to the cathode 120. The separator 130 is operable to separate the anode 110 from the cathode 120 and to enable ion transfer through the separator 130. The electrolyte formulation 140 is a liquid or gel that provides a lithium-ion conduction path between the anode 110 and the cathode 120.

The anode 110 may be constructed of graphite-based and/or silicon-based material, and the cathode 120 may be constructed of a nickel-based or nickel-rich material. The electrolyte formulation 140 may include a lithium salt in a carbonate-based solution, with LiDFBOP present in the electrolyte formulation 140 in an amount from 0.1 part by weight to 5 parts by weight based on 100 parts by weight of the electrolyte formulation 140.

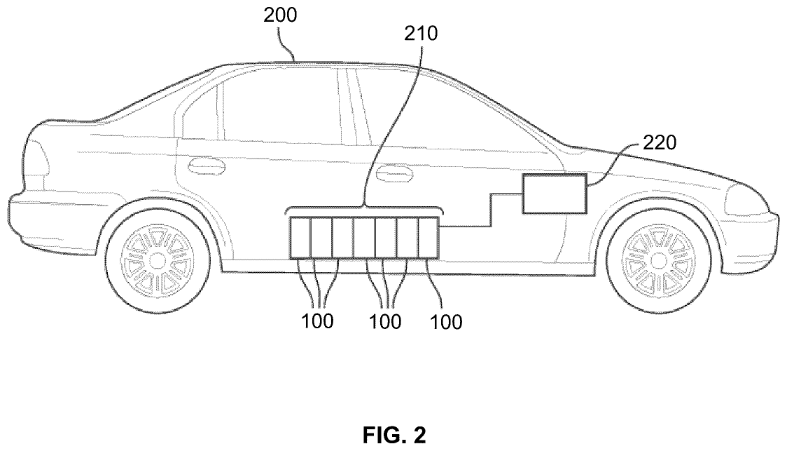

The battery cell 100 may be utilized in a wide range of applications and powertrains. FIG. 2 schematically illustrates an exemplary device 200, e.g., a battery electric vehicle (BEV), including a battery pack 210 that includes a plurality of battery cells 100. The plurality of battery cells 100 may be connected in various combinations, for example, with a portion being connected in parallel and a portion being connected in series, to achieve goals of supplying electrical energy at a desired voltage. The battery pack 210 is illustrated as electrically connected to a motor generator unit 220 useful to provide motive force to the vehicle 200. The motor generator unit 220 may include an output component, for example, an output shaft, which is provided mechanical energy useful to provide the motive force to the vehicle 200. A number of variations to vehicle 200 are envisioned, and the disclosure is not intended to be limited to the examples provided.

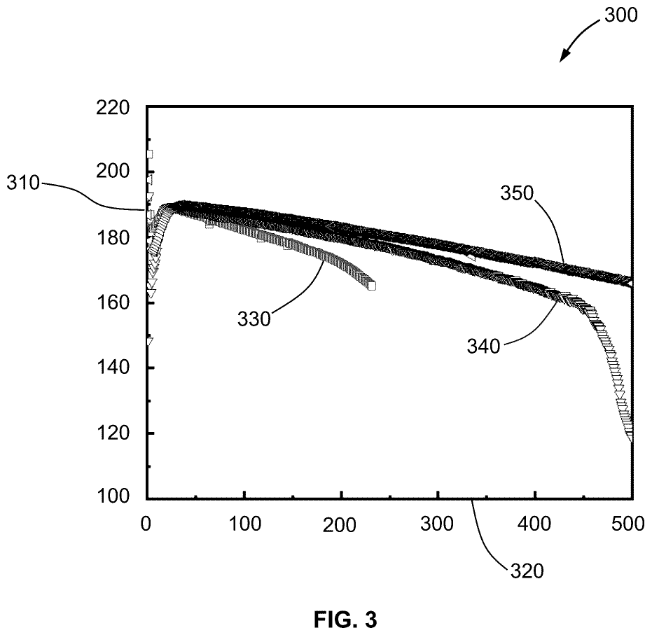

FIG. 3 is a graph 300 illustrating exemplary test results of a relationship between capacity of a battery and a number of operation cycles through which the battery is operated for a plurality of electrolyte formulations in accordance with a first embodiment of the present disclosure. A vertical axis 310 is illustrated describing a specific capacity of the cell in milliamp-hours per gram (mAh/g). A horizontal axis 320 is illustrated describing the number of operation cycles. The anode active components include 20% LiₓSiO_{y} and 80% graphite. The cathode active material includes NCMA (˜5.0 milliamp-hours per square centimeter). Both the anode and the cathode additionally include binder and conductive fillers. Plot 330 illustrates a control electrolyte formulation including 1M LiPF₆ in EC/DMC (3:7). Plot 340 illustrates the control electrolyte (used in plot 330) plus LiDFBOP at 1% by weight. Plot 350 illustrates the control electrolyte plus LiDFBOP at 2% by weight. One may see a significant improvement in specific capacity in plots 340 and 350 as compared to plot 330, which illustrates an improvement in specific capacity as a result of the inclusion of LiDFBOP at both 1% by weight and 2% by weight. (Moreover, the improvement in specific capacity appears to be more pronounced by the inclusion of LiDFBOP at 2% by weight than by the inclusion of LiDFBOP at 1% by weight).

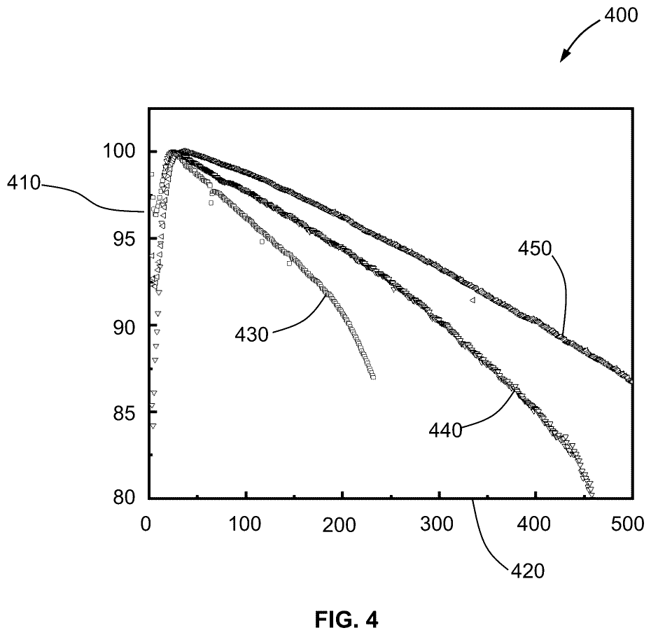

FIG. 4 is a graph 400 illustrating exemplary test results of a relationship between capacity retention of a battery and a number of operation cycles through which the battery is operated for a plurality of electrolyte formulations in accordance with the first embodiment of the present disclosure. A vertical axis 410 is illustrated describing a capacity retention of the cell as a percentage of an original cell capacity. A horizontal axis 420 is illustrated describing the number of operation cycles. The anode active components include 20% LiₓSiO_{y} and 80% graphite. The cathode active material includes NCMA (˜5.0 milliamp-hours per square centimeter). Both the anode and the cathode additionally include binder and conductive fillers. Plot 430 illustrates a control electrolyte formulation including 1M LiPF₆ in EC/DMC (3:7). Plot 440 illustrates the control electrolyte (used in plot 430) plus LiDFBOP at 1% by weight. Plot 450 illustrates the control electrolyte plus LiDFBOP at 2% by weight. One may see a significant improvement in capacity retention in plots 440 and 450 as compared to plot 430, which illustrates an improvement in capacity retention as a result of the inclusion of LiDFBOP at both 1% by weight and 2% by weight. (Moreover, the improvement in capacity retention appears to be more pronounced by the inclusion of LiDFBOP at 2% by weight than by the inclusion of LiDFBOP at 1% by weight).

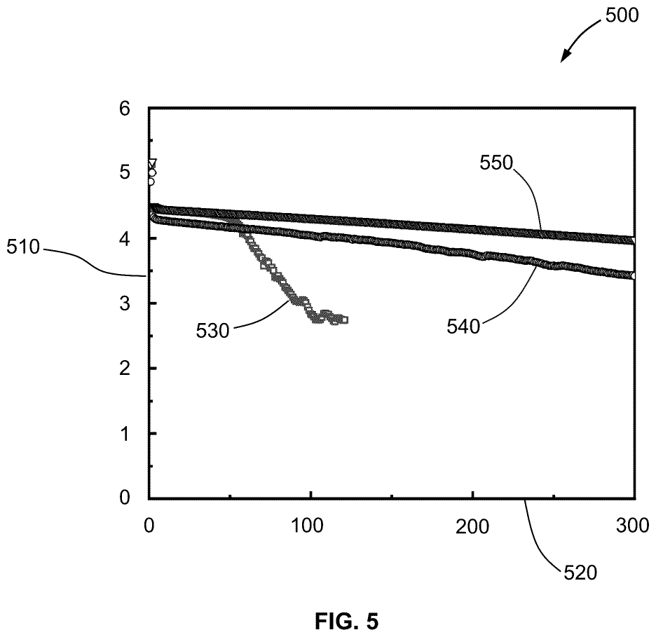

FIG. 5 is a graph 500 illustrating exemplary test results of a relationship between capacity of a battery and a number of operation cycles through which the battery is operated for a plurality of electrolyte formulations in accordance with a second embodiment of the present disclosure. A vertical axis 510 is illustrated describing an areal capacity of the battery in milliamp-hours per square centimeter (mAh/cm²). A horizontal axis 520 is illustrated describing the number of operation cycles. The anode active components include 40% LiₓSiO_{y} and 60% graphite. The cathode active material includes LMR (˜5.0 milliamp-hours per square centimeter.) Both the anode and the cathode additionally include binder and conductive fillers. Plot 530 illustrates a control electrolyte formulation including 1.2M LiPF₆ in FEC/DEC (1:4). Plot 540 illustrates a baseline electrolyte, which includes the control electrolyte (used in plot 530) plus LiPO₂F₂ at 1% by weight. Plot 550 illustrates the control electrolyte plus LiDFBOP at 2% by weight. One may see a significant improvement in areal capacity in plot 550 as compared to both the control electrolyte shown in plot 530 and the baseline electrolyte shown in plot 540, which illustrates an improvement in areal capacity as a result of the inclusion of LiDFBOP at 2% by weight.

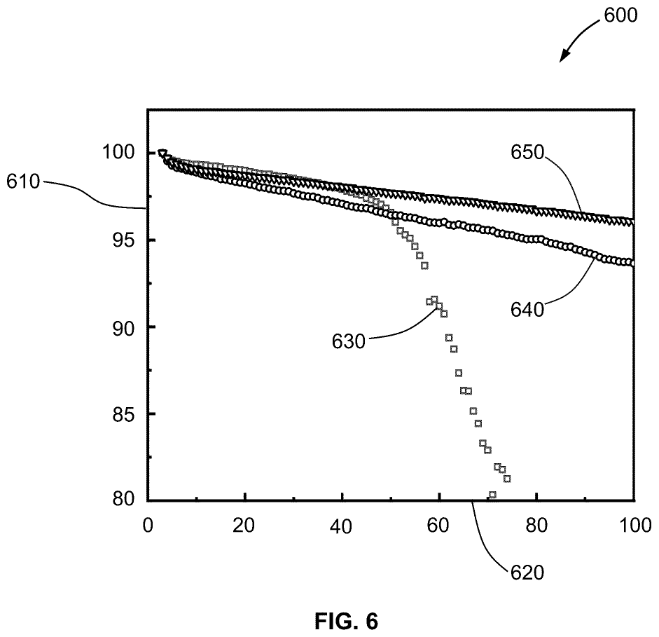

FIG. 6 is a graph 600 illustrating exemplary test results of a relationship between capacity retention of a battery and a number of operation cycles through which the battery is operated for a plurality of electrolyte formulations in accordance with the second embodiment of the present disclosure. A vertical axis 610 is illustrated describing a capacity retention of the battery as a percentage of an original battery capacity. A horizontal axis 620 is illustrated describing the number of operation cycles. The anode active components include 40% LiₓSiO_{y} and 60% graphite. The cathode active material includes LMR (˜5.0 milliamp-hours per square centimeter). Both the anode and the cathode additionally include binder and conductive fillers. Plot 630 illustrates a control electrolyte formulation including 1.2M LiPF₆ in FEC/DEC (1:4). Plot 640 illustrates a baseline electrolyte, which includes the control electrolyte (used in plot 630) plus LiPO₂F₂ at 1% by weight. Plot 650 illustrates the control electrolyte plus LiDFBOP at 2% by weight. One may see a significant improvement in capacity retention in plot 650 as compared to both the control electrolyte shown in plot 630 and the baseline electrolyte shown in plot 640, which illustrates an improvement in capacity retention as a result of the inclusion of LiDFBOP at 2% by weight.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and formulations of matter, and to perform methods, according to this disclosure. It is the following claims, including equivalents, which define the scope of the present disclosure.

What is claimed is:

1. An electrolyte formulation for a battery, the electrolyte formulation comprising:
a lithium salt in a carbonate-based solution; and
lithium difluoro(bisoxalato) phosphate present in the electrolyte formulation in an amount from 0.1 part by weight to 5 parts by weight based on 100 parts by weight of the electrolyte formulation.

2. The electrolyte formulation of claim 1, wherein the lithium difluoro(bisoxalato) phosphate is present in the electrolyte formulation in an amount from 0.5 part by weight to 2.5 parts by weight based on 100 parts by weight of the electrolyte formulation.

3. The electrolyte formulation of claim 1, wherein the lithium difluoro(bisoxalato) phosphate is present in the electrolyte formulation in an amount of 1 part by weight to 2 parts by weight based on 100 parts by weight of the electrolyte formulation.

4. The electrolyte formulation of claim 1, wherein the lithium salt is selected from the group consisting of lithium hexafluorophosphate, lithium tetrafluoroborate, lithium bis(trifluoromethanesulfonyl)imide, lithium bis(oxalato)borate, and lithium perchlorate; and
wherein the lithium salt is present in an amount from 0.5 mole to 4 moles per 1 liter of the carbonate-based solution.

5. The electrolyte formulation of claim 1, wherein the lithium salt includes lithium hexafluorophosphate.

6. The electrolyte formulation of claim 5, wherein the lithium hexafluorophosphate is present in an amount from 0.5 to 4 moles per 1 liter of the carbonate-based solution.

7. The electrolyte formulation of claim 1, wherein the carbonate-based solution includes two solvents selected from the group consisting of dimethyl carbonate, diethyl carbonate, ethylene carbonate, ethyl methyl carbonate, fluoroethylene carbonate, vinylene carbonate and propylene carbonate; and
wherein the two solvents are present in a mixing ratio of from 1:99 to 99:1.

8. The electrolyte formulation of claim 1, wherein the carbonate-based solution includes ethylene carbonate and dimethyl carbonate present in a ratio ranging from 2 parts ethylene carbonate to 9 parts dimethyl carbonate to 6 parts ethylene carbonate to 9 parts dimethyl carbonate.

9. The electrolyte formulation of claim 1, wherein the carbonate-based solution includes fluoroethylene carbonate and diethyl carbonate present in a ratio ranging from 1 part fluoroethylene carbonate to 9 parts diethyl carbonate to 4 parts fluoroethylene carbonate to 9 parts diethyl carbonate.

10. The electrolyte formulation of claim 1, wherein the carbonate-based solution includes ethylene carbonate and dimethyl carbonate present in a ratio of 3 parts ethylene carbonate to 7 parts dimethyl carbonate.

11. The electrolyte formulation of claim 1, wherein the carbonate-based solution includes fluoroethylene carbonate and diethyl carbonate present in a ratio of 1 part fluoroethylene carbonate to 4 parts diethyl carbonate.

12. The electrolyte formulation of claim 3, wherein the lithium salt includes lithium hexafluorophosphate present in an amount from 0.5 mole to 4 moles per 1 liter of the carbonate-based solution, and wherein the carbonate-based solution includes ethylene carbonate and dimethyl carbonate present in a ratio of 3 parts ethylene carbonate to 7 parts dimethyl carbonate.

13. The electrolyte formulation of claim 3, wherein the lithium salt includes lithium hexafluorophosphate present in an amount from 0.5 mole to 4 moles per 1 liter of the carbonate-based solution, and wherein the carbonate-based solution includes fluoroethylene carbonate and diethyl carbonate present in a ratio of 1 part fluoroethylene carbonate to 4 parts diethyl carbonate.

14. A battery comprising:
an anode;
a cathode; and
an electrolyte formulation including:
a lithium salt in a carbonate-based solution; and
lithium difluoro(bisoxalato) phosphate present in the electrolyte formulation in an amount from 0.1 part by weight to 5 parts by weight based on 100 parts by weight of the electrolyte formulation.

15. The battery of claim 14, wherein the anode is a graphite- and/or silicon-based anode, and wherein the graphite- and/or silicon-based anode includes a material selected from the group consisting of (i) silicon, (ii) silicon monoxide, (iii) silicon carbide, (iv) LiₓSiO_{y}, (v) a blend of any of (i)-(iv), (vi) any of (i)-(v) mixed or coated with graphite, and (vii) graphite.

16. The battery of claim 14, wherein the cathode is a nickel-based cathode, and wherein the nickel-based cathode is a mixture including one or more of a nickel-cobalt-manganese-aluminum mixture, a lithium- and manganese-rich layered oxide mixture, a lithium-nickel-manganese-oxide mixture, a nickel-manganese-cobalt mixture, a nickel-cobalt-aluminum mixture, an olivine LiMnₓFe₁₋ₓPO₄ mixture, a lithium-iron-phosphate mixture and a lithium manganese (III,IV) oxide mixture.

17. The battery of claim 14, wherein the lithium difluoro(bisoxalato) phosphate is present in the electrolyte formulation in an amount from 0.5 part by weight to 2.5 parts by weight based on 100 parts by weight of the electrolyte formulation; and
wherein the lithium salt includes lithium hexafluorophosphate present in an amount from 0.5 moles to 4 moles per 1 liter of the carbonate-based solution.

18. The battery of claim 17, wherein the carbonate-based solution includes either:
ethylene carbonate and dimethyl carbonate present in a ratio ranging from 2 parts ethylene carbonate to 9 parts dimethyl carbonate to 6 parts ethylene carbonate to 9 parts dimethyl carbonate; or
fluoroethylene carbonate and diethyl carbonate present in a ratio ranging from 1 part fluoroethylene carbonate to 9 parts diethyl carbonate to 4 parts ethylene carbonate to 9 parts diethyl carbonate.

19. A device comprising:
an output component; and
a battery configured for providing electrical energy to the device, the battery including:
an anode;
a cathode; and
an electrolyte formulation including:
a lithium salt in a carbonate-based solution; and
lithium difluoro(bisoxalato) phosphate present in the electrolyte formulation in an amount from 0.1 part by weight to 5 parts by weight based on 100 parts by weight of the electrolyte formulation.

20. The device of claim 19, wherein the lithium difluoro(bisoxalato) phosphate is present in the electrolyte formulation in an amount from 0.5 part by weight to 2.5 parts by weight based on 100 parts by weight of the electrolyte formulation;
wherein the lithium salt includes lithium hexafluorophosphate present in an amount from 0.5 moles to 4 moles per 1 liter of the carbonate-based solution; and
wherein the carbonate-based solution includes either:
ethylene carbonate and dimethyl carbonate present in a ratio ranging from 2 parts ethylene carbonate to 9 parts dimethyl carbonate to 6 parts ethylene carbonate to 9 parts dimethyl carbonate; or
fluoroethylene carbonate and diethyl carbonate present in a ratio ranging from 1 part fluoroethylene carbonate to 9 parts diethyl carbonate to 4 parts ethylene carbonate to 9 parts diethyl carbonate.
